(19) United States
(12) Patent Application Publication
(10) Pub. No.: US 2020/0062350 A1
(43) Pub. Date: Feb. 27, 2020

(54) A VERY LARGE FLOATING STRUCTURE BASED ON MODULAR UNITS AND A COMBINED MOORING SYSTEM

(71) Applicant: Dalian University of Technology, Dalian City (CN)

(72) Inventors: Nianxin REN, Dalian City (CN); Zhe MA, Dalian City (CN); Hongbo WU, Dalian City (CN); Ling WAN, Dalian City (CN); Jinping OU, Dalian City (CN); Dezhi NING, Dalian City (CN); Gangjun ZHAI, Dalian City (CN); Daocheng ZHOU, Dalian City (CN)

(21) Appl. No.: 16/462,524

(22) PCT Filed: Jan. 2, 2018
(86) PCT No.: PCT/CN2018/070046

§ 371 Date: May 20, 2019

(51) Int. Cl. B63B 35/44; F03B 13/14

(52) U.S. Cl. CPC B63B 35/44; B63B 2035/4466; F03B 13/14

(57) ABSTRACT

A very large floating structure based on modular units and a combined mooring system. The system includes a central large platform module, small outer platform modules, tension-legs, mooring lines, oscillating float-type wave energy converters and module connectors. The oscillating float-type wave energy converters can convert the swinging motion of the floaters into the horizontal motion of the piston rods through the gear wheel-rack transmission. Module connectors between modules are divided into two kinds of modes. One can utilize both relative torsional motion and horizontal motion between the central large platform module and the adjacent small platform modules, while the other simultaneously generates power and reduces the relative motions between the adjacent platform modules. The wave energy converters on the outer modules of the very large floating structure can generate power by absorbing the incident wave energy.

### TECHNICAL FIELD

The present invention belongs to the field of ocean energy utilization, relates to a large floating marine structure, and particularly relates to a very large floating structure based on modular units and a combined mooring system.

### BACKGROUND

Since the development of terrestrial resources gradually become saturated, researchers from many countries have begun to set their sights on ocean, for there still remain rich resources to develop in ocean, in order to promote the exploitation and utilization of marine resources, the researchers have proposed a concept of very large floating structure (VLFS), and have invested heavily in research in this area, VLFS is a special offshore platform structure which has vast area to easily diversify the comprehensive functions and other qualities, it can not only work as a platform for the exploitation of marine resources, and also be used as the extensional area of coastal cities and naval bases, etc. The islands of the South China Sea are far away from the center of mainland, if a very large floating military base can be deploy in the South China Sea, it would be easier to protect and ensure the sovereignty of the islands of the South China Sea. Therefore, it is a significant prospect and strategy to develop VLFS. However, due to the immensity of VLFS and heavy ocean loads, it is necessary to modularize VLFS to several basic discrete models which are spliced together and utilize simple and efficient mooring systems to moor VLFS, so that the VLFS can be easily expanded and multi-functional on the premise of structural safety and stability. Thus, it is significant and meaningful to study the modularization and mooring methods of VLFS.

In the prior art, there are box-typed VLFS, semi-submersible VLFS, etc. Among them, the box-typed VLFS is suitable for mild sea, while the semi-submersible VLFS is suitable for the rough sea, for it is easy to modularize to weaken the impact of sea loads on the VLFS. The type of connector of VLFS modules mainly includes rigid connectors and flexible connectors, among which the rigid connectors can effectively limit the relative movement between the adjacent modules but also suffer from heavy sea loads, while the flexible connectors allow more relative movement between the adjacent modules to reduce the heavy loads. Types of the wave energy generation devices are diversified and non-limited, and include more than ten types such as a nodding duck type, a wave power generating ship type, an atoll type, a rectifier type, an oscillating water column type, a swing type, a shrinking channel type, and so on.

The prior art has the following defects: VLFS usually relies deeply on seawalls or natural barriers such as islands for its poor resistance to heavy sea loads without barriers. Most designs of VLFS proposed to use mooring lines barely, which reveals that it is still lack of the research on the combination of combined mooring systems and wave elimination methods. Moreover, the most designs of VLFS module connectors have some shortcomings such as high design loads and inefficiency in limiting the relative movement between the adjacent modules. Most wave energy converters are highly expensive and working inefficiently in practical applications. There is still lack of VLFS that comprehensively utilizes both wave energy converters and modular connectors to simultaneously generate power and weaken wave loads.

### SUMMARY

The purpose of the present invention is to propose a very large floating structure based on modular units and a combined mooring system, which comprehensively utilizes module connectors and wave energy converters to reduce the heavy wave loads on the very large floating structure and simultaneously improve the utilization efficiency of ocean wave energy and reduce the cost of power generation, and utilizes a combined mooring system which contains tension-legs and mooring lines to limit the motion response of VLFS.

The technical solution of the present invention is as follows:

A very large floating structure based on modular units and a combined mooring system, includes a central large platform module 1, small outer platform modules 2, tension-legs 3, mooring lines 4, cover plates 5, oscillating float-type wave energy converters, module connectors and rubber anti-collision devices 22. The small platforms modules 2 are arranged around the central large platform module 1.

The upper ends of symmetrically distributed tension legs 3 attach to the bottom of the central large platform module 1 and the small platform modules 2 with hinges and the lower ends fix on the seabed, so that the out-of-plane twisting motion of the center large platform module 1 and the small platform modules 2 can be limited. Each platform module has its own tension-legs, considering the characteristics of hydrodynamic load on wave energy converters, module connectors and platform modules, the number and section of tension-legs should be optimized according to the scale of platform modules, the water depth and geological conditions of the site, so that each small platform module has a little self-stability to weakens its dependence and reduces the loads on the central large platform, which does good to the multifunction and the scale expansion of the platform system.

Symmetrically distributed mooring lines 4 moor the four corners of the central large platform module 1 with the sea bed, in order to limit the horizontal movement of the very large floating structure. The combination of mooring lines 4 and tension-legs 3 guarantees the security and stability of the very large floating structure.

The cover plates 5 are set up between the adjacent platform modules (one end of the cover is fixed on one platform, the other end is overlapped on another adjacent platform), in order to connect the adjacent platform modules and improve the integrity of the very large floating structure.

The oscillating floating wave energy converters on the outer modules of the very large floating structure, which can not only utilize the wave energy to generate power but also reduce the incident wave loads on the floating platforms. The oscillating float-type wave energy converter includes a cylindrical floater 6, connecting rods 7, gear transmission devices, bi-directional hydraulic power generation systems which are arranged inside each platform module, bi-directional hydraulic power generation devices in the same platform module can be designed in parallel appropriately. The gear transmission device includes gears 9, fixed shafts 10, racks 11 and horizontal piston rods 12. The bi-directional hydraulic power generation device includes a hydraulic cylinder 13, a first one-way inflow valve 14, a throttling valve 15, a hydraulic motor 16, a power generation device 17, a first one-way outflow valve 18, a second one-way inflow valve 19, a second one-way outflow valve 20, an energy accumulator 21. The cylindrical floater 6 is fixedly connected with gear 9 via connecting rod 7, the gear 9 meshing with the rack 11 can rotate around the fixed shaft 10, the fixed shaft 10 is fixed with the small platform module 2; the bar 11 is fixed on one end of the horizontal piston rod 12, and the other end of the horizontal piston rod 12 stretches horizontally into the hydraulic cylinder 13 of the horizontal hydraulic system.

The working principle of the wave energy converter is described below: when the cylindrical floater 6 swings, it drives the gear 9 to rotate around the fixed shaft 10 which is fixed with a platform module, and the rotation drives the horizontal piston rod 12 via the rack 11 meshing with the gear 9 to perform stretch/compression motion; when the horizontal piston rod 12 performs compression motion, liquid in the hydraulic cylinder 13 is driven to enter the hydraulic motor 16 via the first one-way inflow valve 14 and the throttling valve 15 to drive the motor to rotate, so as to drive the power generation device 17 to generate power, and finally, the liquid returns to the hydraulic cylinder 13 via the first one-way outflow valve 18. When the horizontal piston rod 12 make the stretch motion, the liquid in the hydraulic cylinder 13 is driven to enter the hydraulic motor 16 via the second one-way inflow valve 19 and the throttling valve 15 to drive the motor to rotate, so as to drive the power generation device 17 to generate power, and finally, the liquid returns to the hydraulic cylinder 13 via the second one-way outflow valve 20. The throttling valve 15 and an energy accumulator 21 mainly achieve the purposes of stabilizing pressure of the hydraulic systems and protecting safety of the hydraulic systems.

The module connector includes module connecting rods 8, gear transmission devices and bi-directional hydraulic power generation devices.

The working principle of the bi-directional hydraulic power generation device is the same as that of the bi-directional hydraulic power generation device in the oscillating float-type wave energy generation device; the module connecting rod 8 below the cover plate 5 can be used to connect adjacent platform modules. Module connectors between adjacent platform modules are divided into two kinds of modes according to the relative scale of adjacently connected platform modules, considering the characteristics of hydrodynamic load on wave energy converters and platform modules, the main parameters of each component of the module connectors should be optimized according to the scale and distance of the adjacent platform modules, wave elimination requirement, power generation requirement, etc, in order to effectively reduce the relative movement between the adjacent platform modules and utilize the movement to generate power, and effectively reduce the loads on the module connectors. The two kinds of modes are:

One (mode one) is used to connect the adjacent small platform module 2 with the central large platform module 1, and the relative torsional and bi-directional horizontal movement between the small platform module 2 and the center large platform module 1 can be used to generate power: one end of the module connecting rod 8 is fixedly connected with the gear 9 which is installed with the small platform module 2, labelled as A-end; the other end of the module connecting rod 8 stretches into the large bi-directional hydraulic power generation device in the center large platform module 1, labelled as C-end. When the small platform module 2 moves relative to the center large platform module 1, the gear 9 at A-end can be driven to rotate around the fixed shaft 10 by the module connecting rod 8. Then, the bi-directional hydraulic power generation device (the working principle is the same as that of the bi-directional hydraulic power generation device in the oscillating float-type wave energy converter) fixed with the small platform module 2 is driven by the gear transmission to generate power. The module connecting rod 8 can also be driven to perform stretch/compression motion in the hydraulic cylinder of large-scale bi-directional hydraulic power generation system in the central large platform to generate power at C-end.

The other (mode two) is used to connect adjacent small platform modules 2, and the relative torsional motion between two adjacent small platform modules 2 can be used to generate power: one end of the module connecting rod 8 is fixedly connected with the gear 9 which is installed with one small platform module 2, labelled as A-end; the other end of the module connecting rod 8 is fixed with the other small platform module 2, labelled as B-end. The movement of the adjacent small platform modules 2 drives the gear 9 to rotate around the fixed shaft 10 at A-end via module connecting rod 8, which drives the bi-directional hydraulic power generation device (the working principle is the same as that of the bi-directional hydraulic power generation device in the oscillating float-type wave energy converter) fixed with the small platform modules 2 to generate power via the gear transmission system.

The rubber anti-collision devices 22 which are symmetrically arranged and fixed with the platform modules at A-end in order to prevent the collision of the module connecting rods 8 and the internal of the modules in the extreme situation.

The invention of a very large floating structure based on modular units and a combined mooring system, abides by the design concept of convenience of establishment and expansion and combined mooring system, utilizes wave energy converters, flexible module connectors that can generate power and combined mooring system which includes tension-legs and mooring lines, to propose a kind of very large floating structure that can be modularized and multifunctional on the premise of structural safety and stability, it has beneficial effects as follow:

(1) The oscillating float-type wave energy converters on the outer modules of the very large floating structure, can absorb incident waves energy as a wave energy collecting system and simultaneously reduce the incident wave loads on the platform modules, which means the oscillating float-type wave energy converters can simultaneously reduce the motion response of platform modules and provide considerable energy for the very large floating structure, thereby improve the security of the very large floating structure.

(2) The invention modularizes the very large floating structure into combined platform modules, which facilitate the function regionalization, diversification and expansion of the very large floating structure.

(3) The invention proposes a brand new kind of flexible module connector that can not only connect adjacent platform modules but also utilize the relative motion between the adjacent platform modules to generate power, the function of the module connector can not only reduce the loads on itself and ensure the integrity of the very large floating structure, but also simultaneously provide considerable energy for the very large floating structure.

(4) In order to effectively improve the motion characteristics of the central large platform module, the invention adopts a combined mooring system which includes tension-legs and mooring lines to moor the central large platform module, specifically: the tension-legs constrain its twisting motion; the mooring lines constrain its horizontal movement.

(5) Each small platform module is equipped with a tension-leg to constrain its movement, which means the small platform modules have certain self-stability so that the loads carried from small platform modules to the central large platform module would not be too heavy and the relative movement between the adjacent platform modules could be limited, thus the security and stability of the very large floating structure could be guaranteed and as the premise of multifunction and expansion of the platform system.

### BRIEF DESCRIPTION OF DRAWINGS

FIG. 1 is a front view of a very large floating structure based on modular units and a combined mooring system in the present invention, among which the dash line represents sea level;

FIG. 2(a) is a schematic top view of a very large floating structure based on modular units and a combined mooring system (includes cover plates) in the present invention, among which the dash line represents the edges of the platform modules;

FIG. 2(b) is a schematic top view of a very large floating structure based on modular units and a combined mooring system (exclude cover plates) in the present invention, among which the letter A, B, C refer to the above-mentioned ends of the module connectors;

FIG. 3(a) is a front view of the oscillating float-type wave energy converter in the present invention;

FIG. 3(b) is a schematic top view of the oscillating float-type wave energy converter in the present invention, among which the two ends of the fixed shaft 10 are fixed with the platform module, and letter E represents the bi-directional hydraulic power generation system without the portion of the hydraulic cylinder.

FIG. 4(a) is a schematic cross-sectional front view of the mode one of the module connector in the present invention.

FIG. 4(b) is a schematic cross-sectional top view of the mode one of the module connector in the present invention.

FIG. 5(a) is a schematic cross-sectional front view of the mode two of the module connector in the present invention.

FIG. 5(b) is a schematic cross-sectional top view of the mode two of the module connector in the present invention.

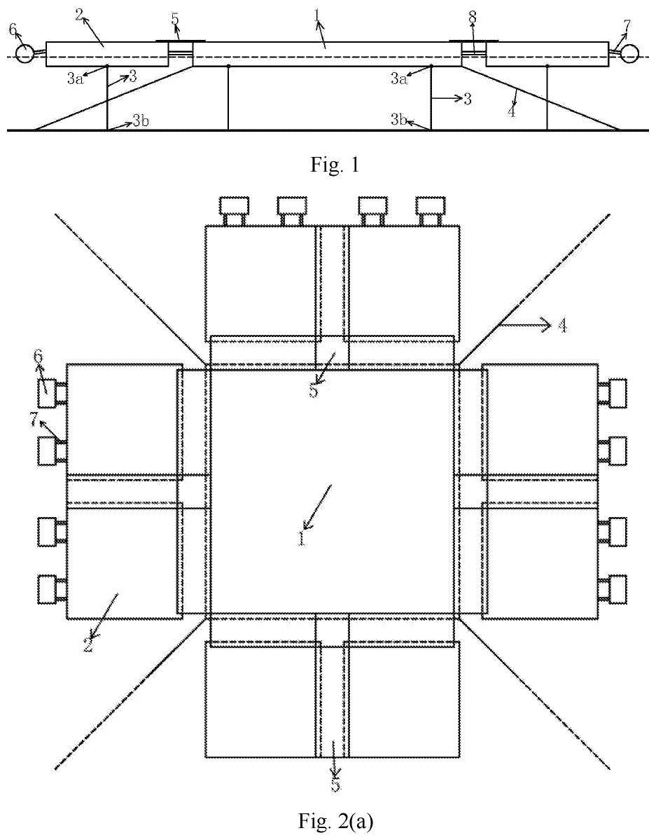

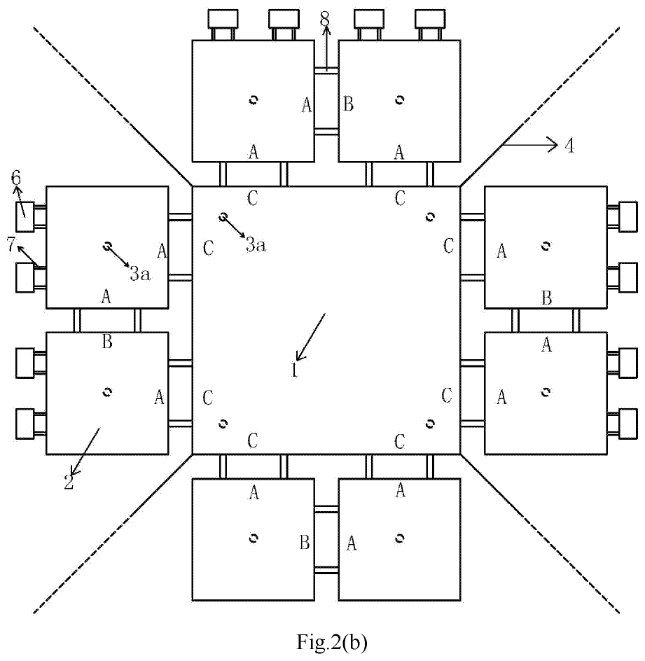

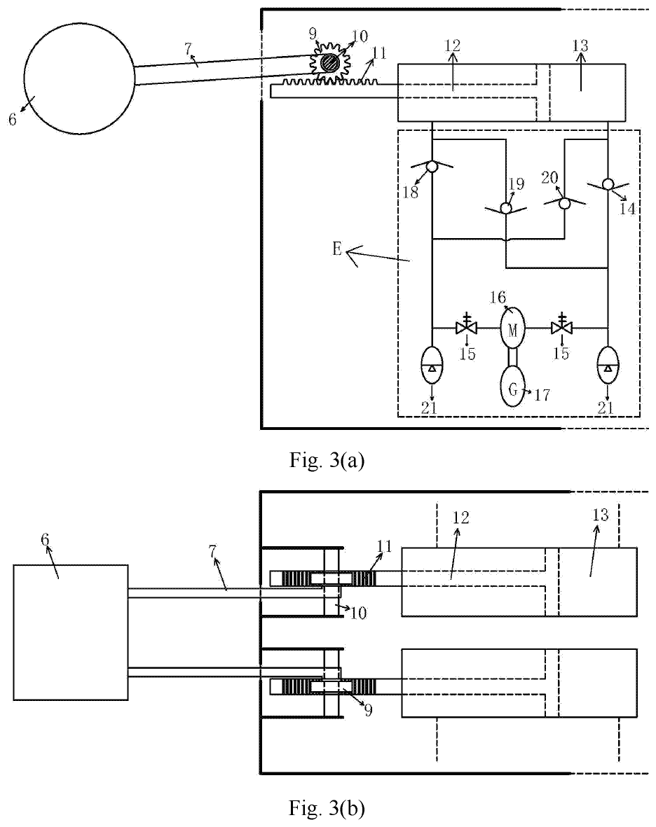

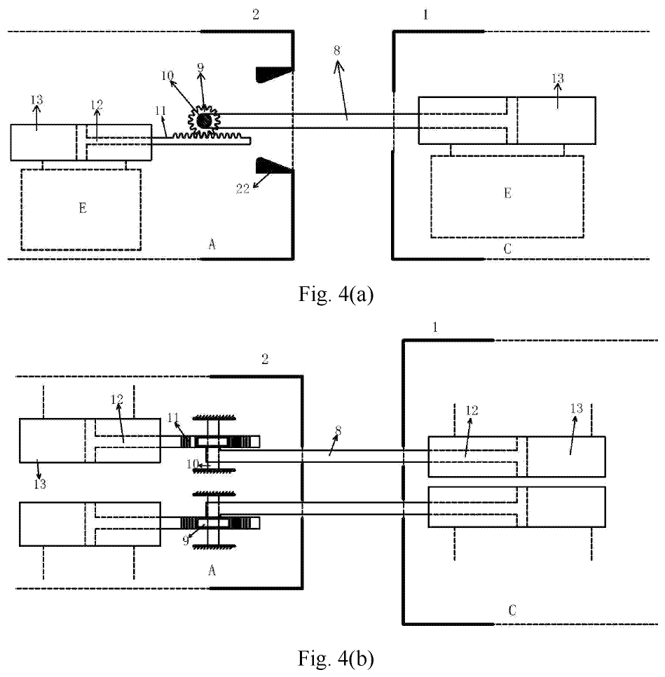

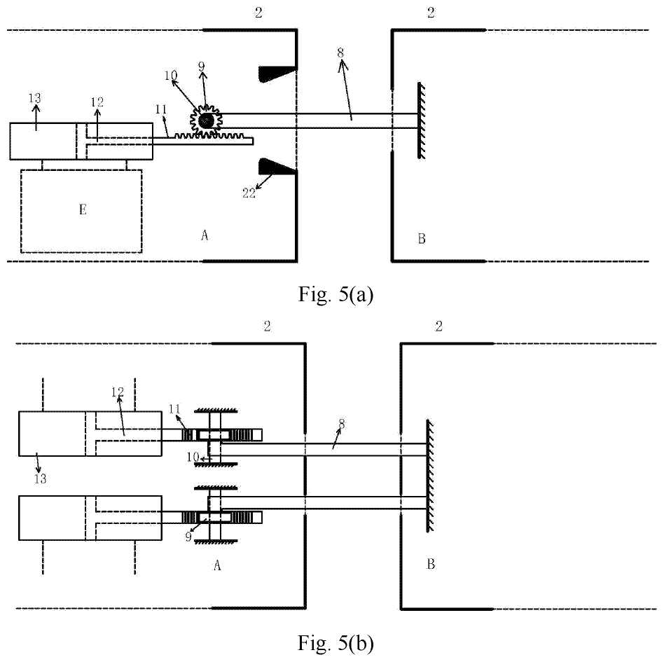

In the figures: 1 central large platform module; 2 small platform module; 3 tension-leg; 3a the upper end of the tension-leg which attaches to the bottom of platform module with hinges; 3b the lower end of the tension-leg which is fixed on the seabed; 4 mooring lines system; 5 cover plates; 6 cylindrical floater; 7 connecting rod; 8 module connecting rod; 9 gear; 10 fixed shaft; 11 rack; 12 horizontal piston rod; 13 hydraulic cylinder; 14 the first one-way inflow valve; 15 throttling valve; 16 hydraulic motor; 17 power generation device; 18 the first one-way outflow valve; 19 the second one-way inflow valve; 20 the second one-way outflow valve; 21 energy accumulator; 22 rubber anti-collision devices.

### DETAILED DESCRIPTION

The present invention is further described below in combination with drawings and specific embodiments.

A very large floating structure based on modular units and a combined mooring system, includes a central large platform module 1, small platform modules 2, tension-legs 3, mooring lines 4, cover plates 5, oscillating float-type wave energy converters, module connectors and rubber anti-collision devices 22. The small platforms modules 2 are arranged around the central large platform module 1. The tension-legs 3 includes several symmetrically distributed tension legs whose upper ends (labelled as 3a) attach to the bottom of the central large platform module 1, and lower ends (labelled as 3b) is fixed on the seabed. The mooring lines 4 includes several symmetrically distributed mooring lines which moor the four corners of the central large platform module 1 with the sea bed, in order to limit the horizontal movement of the very large floating structure. The cover plates 5 whose shape includes rectangle and square are set up between the adjacent platform modules. The oscillating float-type wave energy converters on the outer modules of the very large floating structure, which can not only utilize the wave energy to generate power but also reduce the incident wave loads on the floating structure.

Two brand new kinds of flexible module connector are used to connect the adjacent platform modules, one (mode one) is used to connect the central large platform module with the adjacent small platform module, the other (mode two) is used to connect two adjacent small platform modules, both of the modes can generate considerable power and effectively alleviate the relative movement between the adjacent platform modules, among which the mode one of the module connector can utilize the relative torsional and bi-directional horizontal movement between the small platform module and the center large platform module to generate power, while the mode two of the module connector can utilize the relative torsional motion between two adjacent small platform modules to generate power, so as to provide considerable energy for the very large floating structure, reduce the relative movement between the adjacent platform modules and ensure the overall stability of the entire very large floating structure.

A combined mooring system which includes tension-legs and mooring lines is used to moor the central large platform module, among which the mooring lines constrain its horizontal movement, the tension-legs constrain its out-of-plane twisting motion, the combined mooring system can effectively improve the motion characteristics of the central large platform module and ensure its security and stability. Each small platform module is equipped with a tension-leg to constrain its movement, which means the small platform modules have certain self-stability so that the loads carried from small platform modules to the central large platform module would not be too heavy, thus the security and stability of the very large floating structure could be guaranteed and as the premise of multifunction and expansion of the platform system.

The oscillating float-type wave energy converter includes a cylindrical floater 6, connecting rods 7, gear transmission devices, bi-directional hydraulic power generation systems which are arranged inside each platform module, bi-directional hydraulic power generation devices in the same platform module can be designed in parallel appropriately. The gear transmission device includes gears 9, fixed shafts 10, racks 11 and horizontal piston rods 12. The bi-directional hydraulic power generation device includes a hydraulic cylinder 13, a first one-way inflow valve 14, a throttling valve 15, a hydraulic motor 16, a power generation device 17, a first one-way outflow valve 18, a second one-way inflow valve 19, a second one-way outflow valve 20, an energy accumulator 21. The cylindrical floater 6 is fixedly connected with gear 9 via connecting rod 7, the gear 9 meshing with the rack 11 can rotate around the fixed shaft 10, the fixed shaft 10 is fixed with the small platform module 2; the bar 11 is fixed on one end of the horizontal piston rod 12, and the other end of the horizontal piston rod 12 stretches horizontally into the hydraulic cylinder 13 of the horizontal hydraulic system.

The working principle of the wave energy converter is described below: when the cylindrical floater 6 swings, it drives the gear 9 to rotate around the fixed shaft 10 which is fixed with a platform module, and the rotation drives the horizontal piston rod 12 via the rack 11 meshing with the gear 9 to perform stretch/compression motion; when the horizontal piston rod 12 performs compression motion, liquid in the hydraulic cylinder 13 is driven to enter the hydraulic motor 16 via the first one-way inflow valve 14 and the throttling valve 15 to drive the motor to rotate, so as to drive the power generation device 17 to generate power, and finally, the liquid returns to the hydraulic cylinder 13 via the first one-way outflow valve 18. When the horizontal piston rod 12 make the stretch motion, the liquid in the hydraulic cylinder 13 is driven to enter the hydraulic motor 16 via the second one-way inflow valve 19 and the throttling valve 15 to drive the motor to rotate, so as to drive the power generation device 17 to generate power, and finally, the liquid returns to the hydraulic cylinder 13 via the second one-way outflow valve 20. The throttling valve 15 and an energy accumulator 21 mainly achieve the purposes of stabilizing pressure of the hydraulic systems and protecting safety of the hydraulic systems.

The module connector includes module connecting rods 8, gear transmission devices and bi-directional hydraulic power generation devices.

The working principle of the bi-directional hydraulic power generation device is the same as that of the bi-directional hydraulic power generation device in the oscillating float-type wave energy generation device; the module connecting rod 8 below the cover plate 5 can be used to connect adjacent platform modules. Module connectors between adjacent platform modules are divided into two kinds of modes:

One (mode one) is used to connect the adjacent small platform module 2 with the central large platform module 1, and the relative torsional and bi-directional horizontal movement between the small platform module 2 and the center large platform module 1 can be used to generate power: one end of the module connecting rod 8 is fixedly connected with the gear 9 which is installed with the small platform module 2, labelled as A-end; the other end of the module connecting rod 8 stretches into the large-scale bi-directional hydraulic power generation device in the center large platform module 1, labelled as C-end. When the small platform module 2 moves relative to the center large platform module 1, the gear 9 at A-end can be driven to rotate around the fixed shaft 10 by the module connecting rod 8. Then the bi-directional hydraulic power generation device fixed with the small platform module 2 is driven by the gear transmission to generate power. The module connecting rod 8 can also be driven to perform stretch/compression motion in the hydraulic cylinder of large-scale bi-directional hydraulic power generation system in the central large platform to generate power at C-end.

The other (mode two) is used to connect adjacent small platform modules 2, and the relative torsional motion between two adjacent small platform modules 2 can be used to generate power: one end of the module connecting rod 8 is fixedly connected with the gear 9 which is installed with one small platform module 2, labelled as A-end; the other end of the module connecting rod 8 is fixed with the other small platform module 2, labelled as B-end. The movement of the adjacent small platform modules 2 drives the gear 9 to rotate around the fixed shaft 10 at A-end via module connecting rod 8, which drives the bi-directional hydraulic power generation device fixed with the small platform modules 2 to generate power via the gear transmission system.

A combined mooring system which includes tension-legs and mooring lines is used to moor the central large platform module, considering the characteristics of hydrodynamic load on module connectors and central large platform module, the section of tension-legs and the number of mooring lines should be optimized according to the scale of the central large platform module, the depth of the site and environmental conditions, so as to effectively improve the motion characteristics of the very large floating structure and ensure its security and stability. Each platform module has its own tension-leg, considering the characteristics of hydrodynamic load on wave energy converters, module connectors and platform modules, the section of tension-legs should be optimized according to the scale of platform modules, the depth of the site and environmental conditions, so that each small platform module has a little self-stability to weakens its dependence and reduces the loads on the central large platform, which does good to the multifunction and the scale expansion of the platform system.

Product design in the present invention should consider the following factors:

(1) The scale, shape, number and distribution mode of the wave energy converter should be optimized according to the wave statistical characteristics of the site, the scale of the platform modules, berth design, wave elimination requirement, power generation requirement, etc. So that the wave energy converters can absorb the energy of the incident wave as much as possible and effectively reduce the wave loads on the very large floating structure;

(2) Considering the characteristics of hydrodynamic load on wave energy converters and platform modules, the main parameters of each component of the module connectors should be optimized according to the scale and distance of the adjacent platform modules, wave elimination requirement, power generation requirement, etc, in order to effectively constrain the relative movement between the adjacent platform modules and utilize the movement to generate power, and effectively reduce the loads on the module connectors.

(3) Considering the characteristics of hydrodynamic load on wave energy converters and platform modules, the main parameters of the symmetrically arranged tension-legs and mooring lines should be optimized according to the scale of platform modules, the water depth and geological conditions of the site, so that the twisting and horizontal motion of the platform modules can be limited and the security and durability of the very large floating structure and the combined mooring system can be ensured.

A construction and installation process of a very large floating structure based on modular units and a combined mooring system includes: \textcircled{1} fix the lower ends of the tension-legs system 3 on the seabed which locates on the site of platform modules according to the design and the existing construction technology of tension-leg platform; \textcircled{2} install the main components of the module connectors (exclude module connecting rod 8) in the preset opening which is inside each platform module on the dock, and test the working efficiency of the module connectors; \textcircled{3} install and connect the wave energy converters with the corresponding small platform modules 2, and test their working efficiency; \textcircled{4} transport the central large platform module 1 to the installation site of the corresponding tension-legs system 3 by using a professional construction ship, and attach the upper ends of the tension-legs system 3 to the bottom of the central large platform module 1 with hinges; \textcircled{5} moor the central large platform module 1 with the mooring lines 4; \textcircled{6} transport the small platform modules to the installation site of the corresponding tension-legs systems 3 by using a professional construction ship, and attach the upper ends of the tension-legs systems 3 to the bottom of the small platform modules 2 with hinges in outward sequence of the central large platform module 1; \textcircled{7} install the module connectors and cover plates between the adjacent platform modules in outward sequence of the central large platform module 1 to complete the construction and installation of a very large floating structure based on modular units and a combined mooring system.

1. A very large floating structure based on modular units and a combined mooring system, wherein it involves a central large platform module, small outer platform modules, tension-legs, mooring lines, cover plates, oscillating float-type wave energy converters and module connectors; the small platform modules are arranged around the central platform module, the symmetrically arranged tension legs are used to limit the out-of-plane torsional motion of the central large platform module and the small platform modules; the symmetrically arranged mooring lines moor the four corners of the central large platform module with the sea bed; the cover plates are set up between the adjacent platform modules, in order to connect the adjacent platform modules and improve the integrity of the very large floating structure; the oscillating floating wave energy converters on the outer modules of the very large floating structure, which can not only utilize the wave energy to generate power but also reduce the incident wave loads on the floating platforms;
the oscillating float-type wave energy converter includes a cylindrical floater, connecting rods, gear transmission devices, bi-directional hydraulic power generation systems which are arranged inside each module; the gear transmission device includes gears, fixed shafts, racks and horizontal piston rods; the cylindrical floater is fixedly connected with gear via connecting rod; the gear meshing with the rack can rotate around the fixed shaft, the fixed shaft is fixed with the small platform module; the bar is fixed on one end of the horizontal piston rod, and the other end of the horizontal piston rod stretches horizontally into the horizontal hydraulic cylinder of the hydraulic system; when the cylindrical floater swings, it drives the gear to rotate around the fixed shaft, and the rotation drives the horizontal piston rod via the rack meshing with the gear to perform stretch/compression motion which drives the power generation device in the bi-directional hydraulic power generation device to generate power;
the module connector includes module connecting rods, gear transmission devices and bi-directional hydraulic power generation devices, the working principle of the bi-directional hydraulic power generation device is the same as that of the bi-directional hydraulic power generation device in the oscillating float wave energy converter; the module connecting rod below the cover plate is used to connect adjacent platform modules, there are two kinds of module connector:
one is used to connect the adjacent small platform module with the central large platform module, and the relative torsional and bi-directional horizontal movement between the small platform module and the center large platform module can be used to generate power: one end of the module connecting rod is fixedly connected with the gear which is installed in the small platform module, labelled as A-end; the other end of the module connecting rod stretches into the large bi-directional hydraulic power generation device in the center large platform module, labelled as C-end, when the small platform module moves relative to the center large platform module, the gear at A-end can be driven to rotate around the fixed shaft by the module connecting rod, then the bi-directional hydraulic power generation device fixed inside the small platform module is driven by the gear transmission to generate power, the module connecting rod can also be driven to perform stretch/compression motion in the hydraulic cylinder of large-scale bi-directional hydraulic power generation system in the central large platform to generate power at C-end;
the other is used to connect adjacent small platform modules, and the relative torsional motion between those adjacent small platform modules can be used to generate power: one end of the module connecting rod is fixedly connected with the gear which is installed with one small platform module, labelled as A-end (the same as above); the other end of the module connecting rod is fixed in the other small platform module, labelled as B-end; the movement of the adjacent small platform modules drives the gear to rotate around the fixed shaft at A-end via module connecting rod, which drives the bi-directional hydraulic power generation device fixed in the small platform modules to generate power via the gear transmission system.

2. The very large floating structure based on modular units and a combined mooring system according to claim 1, wherein the bi-directional hydraulic power generation device includes a hydraulic cylinder, a first one-way inflow valve, a throttling valve, a hydraulic motor, a power generation device, a first one-way outflow valve, a second one-way inflow valve, a second one-way outflow valve, an energy accumulator; the specific way that the reciprocating stretch/compression motion of the horizontal piston rod drives the power generation device to generate power is:
when the horizontal piston rod makes the compression motion, liquid in the hydraulic cylinder is driven to enter the hydraulic motor via the first one-way inflow valve and the throttling valve to drive the motor to rotate, so as to drive the power generation device to generate power, and finally, the liquid returns to the hydraulic cylinder via the first one-way outflow valve; when the horizontal piston rod makes the stretch motion, the liquid in the hydraulic cylinder is driven to enter the hydraulic motor via the second one-way inflow valve and the throttling valve to drive the motor to rotate, so as to drive the power generation device to generate power, and finally, the liquid returns to the hydraulic cylinder via the second one-way outflow valve; the throttling valve and an energy accumulator mainly serve to stabilize the pressure of the hydraulic system and ensure the safety of the hydraulic system.

3. The very large floating structure based on modular units and a combined mooring system according to claim 1, wherein it includes rubber anti-collision devices which are symmetrically arranged on the platform modules in order to prevent the collision of the module connecting rod and the internal of modules in the extreme situation.
